(19) United States
(12) Patent Application Publication
(10) Pub. No.: US 2010/0302035 A1
(43) Pub. Date: Dec. 2, 2010

(54) GLOBAL ELECTRONIC SYSTEM OF ENERGY SAVINGS AND INDIVIDUAL SECURITIES

(76) Inventor: Pascal Voisin, Paris (FR)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 12/599,613

(22) PCT Filed: Sep. 14, 2007
(86) PCT No.: PCT/IB2007/003654

§ 371 Date: Apr. 12, 2010

(30) Foreign Application Priority Data
May 10, 2007 (FR) 07/03329
May 29, 2007 (FR) 07/03776

(51) Int. Cl. G08B 21/00

(52) U.S. Cl. 340/540

(57) ABSTRACT

This electronic device offers a complete and total system, for the consumer, since the acquisition of the data to control to visualization by direct display or/and by transmission via Internet and/or the telephone line of various information related with the consumption of water, gas, electricity and telephone as well as data concerning safety of the people such as the smoke detection, of escape of gas, excessive heat and pollution. Other elements, such as the hour, the date, and interior or external temperatures are present. According to the chosen version, an intercom or a videophone exists. Information concerning consumption of the various fluids is taken using sensors or by the addition of additional meters placed at the beginning of the installation right after the “official” meters. Once the data transmitted by telegraphic way or without wire, they are delivered in a microcontroller allowing the treatment and digital display, on a case. Certain data can be regulated by the consumer. At the time of the presence of an anomaly concerning information of the various detectors relating to the safety of the people (pollution and heat, gas, smoke detector), a visual signal is present compared to the fault detector. A siren is also present: it is with several tones following detection (not desired intrusion, detection . . . ) The case is intended to be placed in any room that it is a housing, an office, a factory, a trade, etc (the list not being exhaustive). By the present invention, various consumptions are better controlled and thus decreased, thus contributing to a better environment. In addition, thanks to this invention, the physical safety is ensured in the buildings.

The patent consists in developing a complete and total solution since the acquisition of the data to control to visualization by direct posting or/and by transmission via Internet and/or the telephone line of various information related with the consumption of water, gas, electricity and telephone as well as data concerning safety of the people such as the smoke detection, of escape of gas, excessive heat and pollution.

A siren starting at the time of a not desired intrusion is also present. According to the versions of the product, an intercom or a Videophone is present.

Information such that the date, the hour, the temperatures interior and external exist.

This system is intended to be placed in any room that it is a housing, an office, a factory, a trade, etc (the list not being exhaustive).

This system is intended to the consumer so that this last has information in real time of its various consumption of water, of gas, of electricity and telephone. It is indeed to prove that the fact of having this information allows a reduction being able to go up to −20% of normal consumption. Except the fact that this reduction will cause a drop in the total of the invoices, this reduction will also contribute to keep our planet own for the generations to come.

The originality of this product lies in the fact that it offers a total solution since the acquisition of the data until their visualization.

Indeed, the installation of a single case is, enough in order to be able to visualize this various information.

Currently, the various meters relating to water, the gas and electricity are very often placed in places badly easy and difficult of access and thus the visualization of consumption is hardly possible.

With regard to telephone consumption, very often it is known only with the reception of the invoice.

Also, to obtain this various information, the consumer needs, currently, to utilize various people receiving benefits:
companies specialized in safety for the installation of an alarm anti-intrusion
electrician for the installation of an electric meter
plumber for the installation of a gas meter
companies specialized in the installation of the individual water meters
companies specialized in fire protection.
. . . .

And in spite of these various speakers, the taking into account of the detection of pollution inside the room was never taken into account. However, the studies show that the interior of the buildings is polluted often more than outside: presence of products of cleaning, presence of adhesive . . . .

The result of this state of the facts was that the consumer found himself with several apparatuses. With this product, the consumer will have all this information concentrated at the same place and ease of access.

The invention thus relates to a total process of control of the consumption of resources and data relating to the individual safety which is in conformity with claim 1. Preferred modes of implementation of this process are detailed with claims 2 to 11. The invention also relates to a total and centralized system to control the consumption of resources and data relating to the individual safety which is in conformity with claim 12. Particular modes of realization of this system are detailed in claims 13 to 15.

Description will be understood better and other goals, advantages and characteristic of this one will appear more clearly with the reading of the description which follows and which is made in comparison with the annexed figures which represent nonrestrictive examples of implementation of the invention:

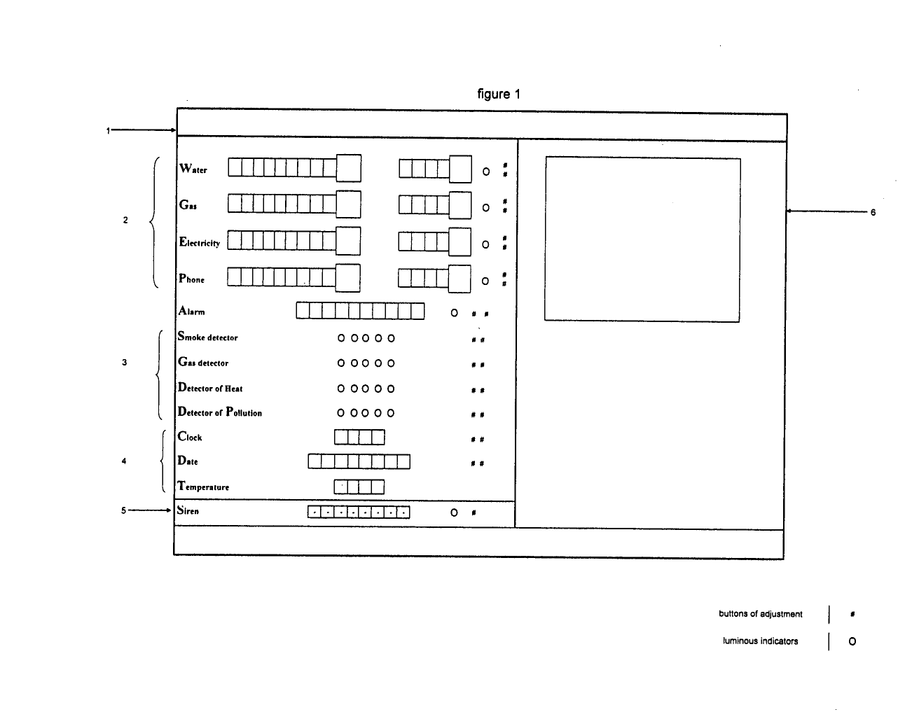

FIG. 1: presentation of the front face of the product

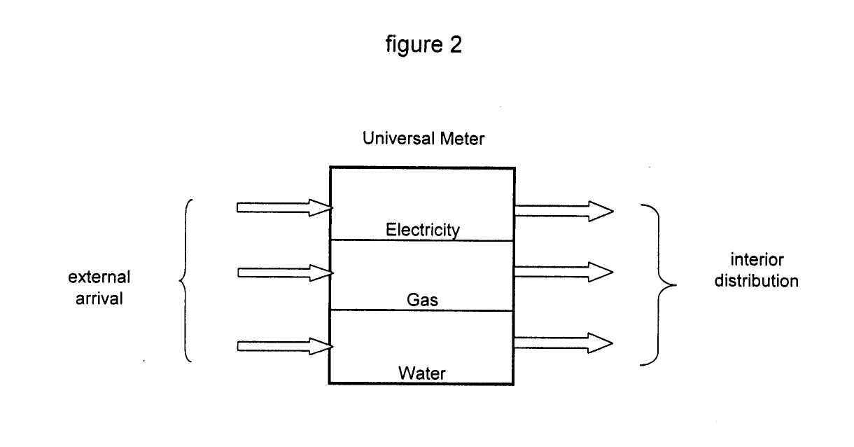

FIG. 2: acquisition of the data starting from the various “official” meters

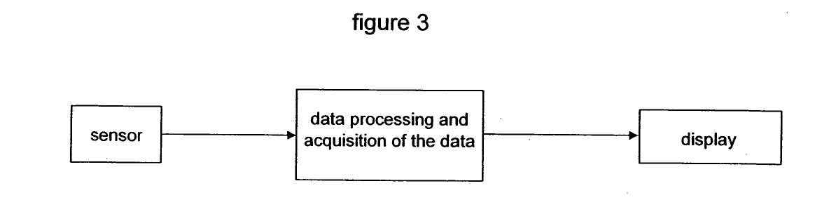

FIG. 3: transmission of the data

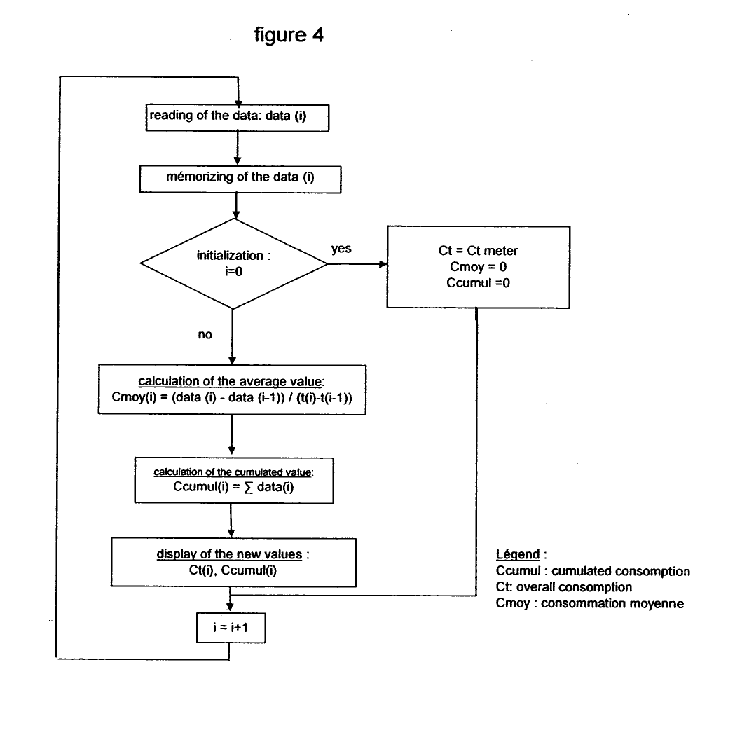

FIG. 4: data processing and display

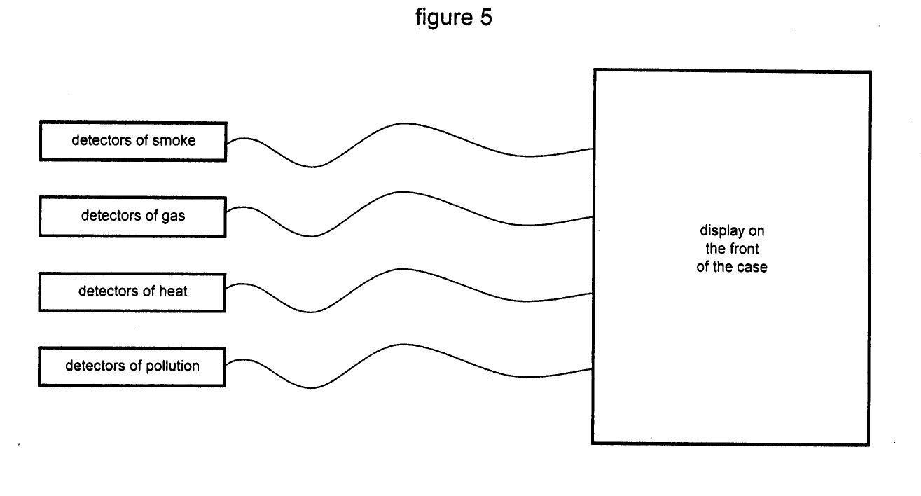

FIG. 5: acquisition of the data starting from the various detectors

On the screen of the product, it appears clearly—to see FIG. 1:

1—overall consumptions and cumulated between two moments of the resources such as water, gas, electricity and telephone. (2)
2—smoke detectors, detectors of gas (in the event of escape), detectors of heat and detectors of pollution.

According to the configuration of the room (a number of parts, presence or not of stages . . . ), one or more detectors will be installed. (3)

3—the posting of the hour, dates, temperature (interior and external) (4)
4—a siren with various tonalities according to detection (5).
5—the intercom part or Videophone (according to the selected version) (6).

This product falls under a whole line of goods. Also according to the model, certain applications cannot be proposed.

### Presentation of the Product:

The project thus consists in developing a complete solution since the acquisition of the data until their visualization on the screen of the product.

### I—Data Relating to Consumption:

We will treat, in this part, only the acquisition of the data relating to water, gas, electricity and the telephone.

1—Acquisition of the Data Starting from the Various “Official” Meters—to See FIG. 2:

The acquisition of these data will be done starting from the official meters. It is clearly understood that neither modification nor intervention on these meters must be practised.

Several solutions exist in order to gather the data of these meters, such as for example:
the addition of a second meter on the outlet side of the “official” meter
the addition of a sensor with Hall effect with regard to the electric meters and telephone and an electromagnetic rate meter with regard to the water and gas meters.

These various meters are in the majority of cases dispersed and some are outside the room (for example, gas and water meters). Also, once the data recorded using the various sensors, it is necessary to make them forward, that is to say by telegraphic way or hertzian way. This part will be detailed in the following paragraph.

### 2—Transmission of the Data—to See FIG. 3:

Once the acquisition of the data relative to the various meters carried out, it is necessary to transmit this information to the meter for treatment and posting.

This transmission will be able to be made in a telegraphic or hertzian way. The telegraphic solution being sourer will be to privilege as much as possible. But, since the product will be installed in any building existing or new, the two versions are developed. For the version without wire, there is a device in order to free itself from the parasitic waves. In the same way for this version, amplifiers are to be placed so that there is not too much loss of signal.

### 3—Data Processing and Posting—to See FIG. 4:

a) Data Processing:

On the front face of the product the overall consumptions and cumulated between two statements of the various resources are posted:

The overall consumptions are identical to those which are reproduced on the “official” meters. They are regulated with the installation of the apparatus and cannot be modified by the user. A device of detection of fraud is besides present in order to supervise this point.

The restoring of cumulated consumption is possible by the consumer, using the button of adjustment.

Thanks to the presence of a microprocessor, average consumption by resource is calculated, in order to detect a possible over consumption.

Two possibilities exist concerning the assumption of responsibility of over consumption:
there is an external temperature sensor and average consumption is calculated according to the external climatic conditions: average consumption between two statements is calculated, and in this case is regarded as “over consumption”, any consumption average which exceeds this computed value.
is canned (it is an average consumption can be modulated according to the seasons) and any variation “with the rise” involves the release of the luminous indicator automatically: the customer defines an average consumption between two statements and will be regarded as “over consumption”, any consumption surplus with this preset value.

In the event of over consumption of one of the resources, a luminous indicator then sound ignites in with respect to the concerned resource.

The consumption of this product having to be weakest possible, the components answering this requirement were selected.

A function “sleeping mode” is activated in the event of no prolonged consumption of the resource concerned.

With regard to the water meter, an escape must be very quickly comparable with an over consumption. The detection of an escape results in the fact that there is a continuous water flow. Also, any continuous flow with a duration higher than 4 (four) hours must be to regard as an escape and activated the signal of over consumption.

A mode “initialization” is also envisaged. During the mode “initialization”, it is possible to write in the various meters. The mode “initialization” is accessible only once, at the time of the connection of the meter in the dwelling.

A mode “maintenance” is envisaged. In this mode, certain functionalities via the registers are accessible.

The product can be fed either by the sector with presence of a battery which takes over in the event of cut of electricity, or by a pile with Lithium in order to be been free from the problems of power supply cut-off, or also by solar panel. In the event of food by pile, a witness of wear of the piles is present.

A whole line of goods of meters is developed.

As, it should be made sure as the micro processor chosen initially formed well part of a class of micro processors in order to ensure itself of compatibility pine to pine, functional calculus, of tension . . . of these components.

b) Display of the Data:

On the screen of the product, various consumption of the various mentioned resources must display, in digital form, —with knowing water, the gas, electricity and the telephone:
the cumulated consumption since the last statement or the last restoring of this value,
the overall consumption which is displayed on the “official” meter

The various information which is displayed on the screen of the product is intended to be read on line. But, the communication via the computer and/or the telephone line in order to read various data and to make the restoring of certain consumption. To this end, modules of connection to Internet and to the GSM are present in order to inform in real time the private individual.

### II—Data Relative to the Various Detectors Concerning Safety of the People:

In this part, we will treat only data relating to safety of the people.

1—Acquisition of the Data Starting from the Various Detectors—to See FIG. 5:

Various sensors will be placed at various places of the room so, to detect:
the presence of smoke,
the gas leakage,
an excessive rise in heat
a presence of pollution inside the room.

In fact simple detectors can be easily found on the market.

### 2—Transmission of the Data:

The same principle as for the transmission of the data relating to the meters is applied: the transmission can be telegraphic or without wire.

### 3—Data Processing and Posting:

At the time of detection by a sensor of an anomaly, a luminous indicator then an audible alarm resounds starting from the case.

In the event of release of the gas-detector or/and of smoke, there is automatic stop of the electricity and gas meters. A valve is present right after the “official” meters: it allows the closing of the meters. On the other hand their restarting is manual.

With regard to the detector of heat, it starts only if one excessive temperature (>50° C.) is detected.

For the detector of pollution, being given the great possible number of causes of interior pollution, if the detector detects an oxygen rate lower than the normal, it starts alarm.

A button of desactivation/stop is available in with respect to each alarm. It is automatically rearmed after a certain period.

### III—Posting of the Hour, Dates and Temperature:

It is envisaged the possibility of setting the clock right and the good date (leap year, for example), at the request of the user.

There is an internal probe in order to take the interior temperature: it can be connected to the detector of heat.

An external probe also exists in order to collect the outside temperature: this data is necessary for the calculation of the average value in order to determine any over consumption in term of heating (with gas or electric).

### IV—The Siren and Alarm:

The siren is with several tones according to the raised defect.

Concerning anti-intrusion alarm, the choice of technology was made on the least cumbersome system. The system consists of an infra red detector for the people who are connected to a luminous alarm and witness on the front face of the case.

### V—Videophone or Intercom:

According to the versions of the product, a Videophone or an intercom is proposed. The simplest technique concerning this functionality was retained. The presence of this function contributes to the safety of the people.

1. A process of control of the consumption of resources, such as gas, water, electricity or the telephone, and of data relating to safety individual, such as fire, intrusion or pollution comprising:
gathering data relating to consumption of resources and individual safety,
treating these data to detect an anomaly, such as an overconsumption or a defect of safety and
displaying in a centralized way at least the data treated to allow an intervention in order to cure this anomaly.

2. The process according to claim 1, in which the data relating to consumption of the resources are gathered starting from official meters.

3. The process according to claim 1, wherein the data relating to individual safety are gathered starting from sensors.

4. The process according to claim 1, in which the gathered data are transmitted to a system of control carrying out at the same time the treatment and posting of the aforesaid data.

5. The process according to claim 4, in which the aforementioned transmission is carried out by telegraphic way or hertzian way.

6. The process according to claim 1, in which the data processing and displaying are carried out in real time.

7. The process according to claim 1, in which are also displayed the untreated data.

8. The process according to claim 1, in which the data are displayed in numerical form.

9. The process according to claim 1, in which displaying also consists in starting an aural and/or luminous signal.

10. The process according to claim 1, in which the displayed data are also accessible remote, per connection Internet or telephone.

11. The process according to claim 1, in which the aforementioned intervention curing the detected anomaly is carried out automatically or by the user.

12. System to control the consumption of resources, such as gas, water, the electricity and the telephone and of the data relating to individual safety, such as fire, intrusion or pollution, including:
means of reception of the data relating to consumption of the resources and individual safety, —means of the aforesaid treatment given to detect an anomaly, such as an overconsumption or a defect of safety, and
means of data display at least treated.

13. System according to claim 12 in which the means of reception, treatment and displaying are gathered in a single case.

14. System according to claim 12, in which, the means of reception are associated transmission resources per telegraphic way or hertzian way.

15. System according to claim 12 in which, the means of displaying are connected to a computer or a telephone line so that the data are accessible remote.
